(19) United States
(12) Patent Application Publication
(10) Pub. No.: US 2002/0161650 A1
(43) Pub. Date: Oct. 31, 2002

(54) Tabletop terminal for point of sale purchases

(76) Inventors: Douglas O. Buchanan, North Vancouver (CA); Paul Douglas Brock, Coquitlam (CA)

Correspondence Address: Wilson Clark, Attention: Mark M. Yang, 800-885 West Georgia Street, Vancouver, BC, V6C 3H1, CA

(21) Appl. No.: 09/790,590

(22) Filed: Feb. 23, 2001

(51) Int. Cl. G06F 17/60

(52) U.S. Cl. 705/17

(57) ABSTRACT

A method of manufacture of a point of sale terminal for placement in a secure location comprising the following steps: (a) providing a payment terminal having: information output means; means for user input; a processor; and communication means for programming said processor; (b) providing a bill reader; programming said processor to instruct said payment terminal to accept information from said bill reader via said communication means; and connecting said bill reader to said payment terminal via said communication means.

### NOTICE REGARDING COPYRIGHTED MATERIAL

A portion of the disclosure of this patent document contains material which is subject to copyright protection. The copyright owner has no objection to the facsimile reproduction by anyone of the patent document or the patent disclosure as it appears in the public Patent Office file or records but otherwise reserves all copyright rights whatsoever.

### TECHNICAL FIELD

This invention relates to Point of Sale (“POS”) terminals, and more particularly to portable POS terminals, and the use and manufacture thereof, with the ability to accept cash from, and be operable by purchasers.

### BACKGROUND

Tabletop terminals for use by clerks when receiving payment for goods or services are known. The terminals can be used for receiving payment via cards, if the terminal is equipped with a card reader. A card, for the purposes of this document is defined as a card that can be used to store or otherwise provide information about monetary value. Examples of cards include debit cards, credit cards or smart cards. The terminal may also be used for providing the good or services, for example by printing a redeemable coupon or receipt, or providing a code or PIN.

In use, these terminals are controlled by the vendor and are usually operated by a clerk, sometimes with input from the purchaser (for example to enter a PIN for a debit card). The purchaser will select a good or service, such as prepaid cellular phone time, the clerk will enter the appropriate information into the terminal and accept payment from the purchaser. If the purchaser is paying via a card, the clerk will take the card, slide the card through the card reader, enter any further information necessary (or allow the purchaser to enter such information) and once the purchase is approved (for example, the credit card is verified), return the card to the purchaser. If the purchaser is paying via cash, the cash must be given to the clerk who will provide change, and enter any information necessary to the terminal to complete the transaction.

Such terminals have a printer to allow the purchaser and/or vendor to record the transaction, and in the case of a purchase of certain goods or services, such prepaid phone time, provide the good or service (for example, a PIN) to the purchaser. Further the terminals can be used to replenish accounts, for example to add value to a prepaid phone account, or add value to a credit card or smart card.

These terminals operated by a clerk must be small enough to fit in a relatively compact area as the clerk is usually in a small space with other tools and/or merchandise for sale (for example, a cash register). An example of such a terminal is disclosed in U.S. Pat. No. 6,021,944 to Arakaki for a Transaction Terminal for Electronic Purse Transactions and the like. These terminals are used to accept payment by one of two ways: (1) by receiving monetary value (or related information to obtain monetary value) by the use of a card; or (2) by manual input, i.e. a person, usually a clerk, has to enter information about the payment received to the terminal using the keypad or other input means associated with the terminal.

These terminals are adapted for receiving monetary value information. This would include account information for making a transfer in the case of a debit card, account information in the case of a credit card and more detailed transaction information in the case of a smart card. When payment is received via cash, the monetary value information is provided by manual input, for example a clerk entering the amount received on a keypad.

Terminals that accept bills (i.e. “bill terminals”) are also known, and such bill terminals may or may not accept card payment. Bill terminals contain a bill reader for collecting, storing and determining the value of the bill being entered. As such terminals typically have large numbers of bills stored within them, they are a prime target for thieves. For this reason, bill terminals are usually made to be very secure, for example by affixing the terminal to a wall, or by inserting the terminal in a large, heavy frame. The advantage of such terminals is that they do not require the presence of a clerk to operate them, as they can be operated by a purchaser alone.

Also known are terminals with card readers that are combined with traditional cash handling means, for example a cash register. Such terminals require the presence of a clerk to accept money or operate the card reader.

### SUMMARY OF THE INVENTION

A method of manufacture of a point of sale terminal for placement in a secure location is provided comprising the following steps: (a) providing a payment terminal having: information output means; means for user input; a processor; and communication means for programming said processor; (b) providing a bill reader; programming said processor to instruct said payment terminal to accept information from said bill reader via said communication means; and connecting said bill reader to said payment terminal via said communication means.

A further method of manufacture of a point of sale terminal for placement in a secure location is provided comprising the following steps: (a) providing a payment terminal adapted for receiving monetary value information via cards or via manual input; providing a bill reader; programming said payment terminal to receive payment value information from said bill reader; and connecting said bill reader to said payment terminal.

A method for a purchaser to make a purchase is provided comprising the steps of: providing a portable, standalone point of sale terminal in a secure location having: a bill reader; information output means; a processor; and means for user input; said purchaser selecting a purchase using said input means; said purchaser paying for said purchase by placing cash within said bill reader.

A stand alone point of sale terminal for placement in a secure location and for use by a purchaser is provided comprising: information output means; means for user input; a processor; a bill reader; and means for storing bills; wherein said terminal is portable.

### BRIEF DESCRIPTION OF FIGURES

Further objects, features and advantages of the present invention will become more readily apparent to those skilled in the art from the following description of the invention when taken in conjunction with the accompanying drawings, in which:

FIG. 1 is a perspective view of a prior art terminal with a card reader;

FIG. 2 is a block diagram of thereof;

FIG. 3 is a front view of a bill terminal;

FIG. 4 is a perspective view of a bill reader for use in the invention;

FIG. 5 is a view of a terminal according to the inventions, showing the connections therein;

FIG. 6 is a perspective view of an embodiment of a terminal according to the invention;

FIG. 7 is a perspective view thereof, wherein the cover plate has been removed;

FIG. 8 is a block diagram of the software to operate the terminal; and

FIG. 9 is a flowchart showing the use of the terminal with bills.

### DETAILED DESCRIPTION OF PREFERRED EMBODIMENTS

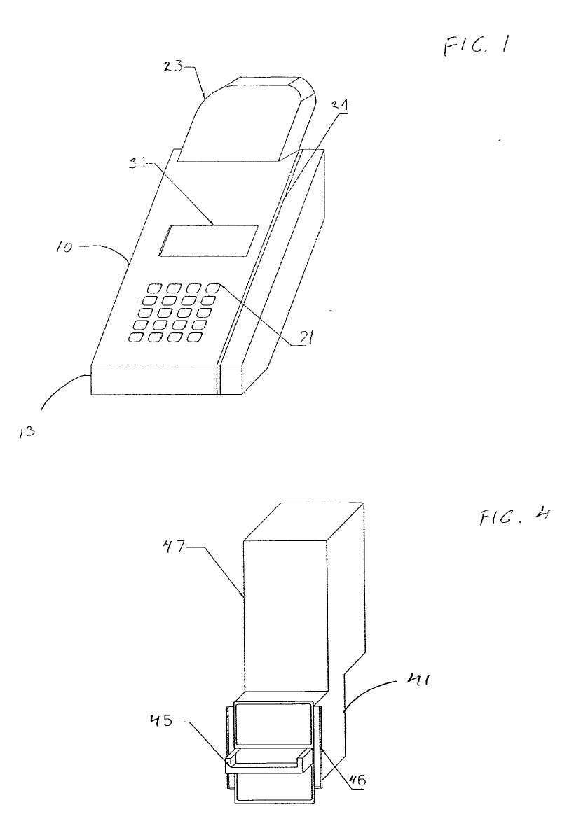

As best seen in FIG. 1, tabletop terminals for reading cards are known in the art. An example of such a terminal is the desktop terminal sold under the trade-mark VERIFONE OMNI 3350. The terminal 10 includes a compact frame 13; means for user input, such as keypad 21 or switches, for entering information about the purchase; a display 31; and a printer 23 for printing a receipt or other information. Optionally, a card reader 24 for reading cards, such as debit, credit and/or smart cards, is included. A further option is a speaker (not shown) for making an audible signal or beeper to indicate to the user when certain steps in the transaction are completed.

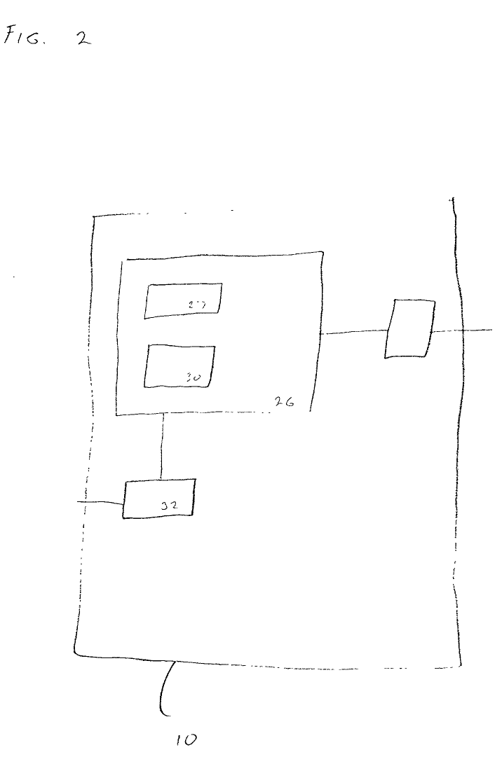

As seen in FIG. 2, inside the terminal on programmable chip 26 is a processor 27, and a memory 30. Terminal 10 also has a modem 32 for communicating with an external server, which is typically a dial up modem, or may be an ISDN modem or a GSM modem. Terminal 10 also has communication means 35, typically a communication port. This allows users of terminal 10 to transmit a program for processor 27 to memory 30 via port 35. Port 35 is preferably a standard RS-232 port. Modem 32 allows terminal 10 to communicate with a network, for example to allocate PIN numbers for prepaid phone cards, or for obtaining authorization for a debit or credit card.

Terminal 10 is used by a clerk, for example at a cash register. When a purchase is made via a card, the clerk enters the necessary information via the keypad 21, accepts payment from the purchaser by accepting cash, or by swiping a card offered by the purchaser through card reader 18 and entering any other necessary information via keypad 21. Once the transaction is processed, the card is returned to the purchaser.

As best seen in FIG. 3, a bill terminal 50 for receiving cash has a bill reader 53, a keypad 55, a display 57 and preferably a card reader 60 allowing the terminal to also read debit, credit and/or smart cards. The frame 63 of terminal 50 is large and bulky to make it difficult to remove.

When a bill is entered and accepted by bill reader 53, it is stored in storage means (not shown). The storage means are typically protected by more than one security means (locks, alarms and the like).

Such terminals are used directly by purchasers, i.e. there is usually no clerk nearby to assist with the transaction (although guards or other personnel may be present). For the purposes of this document the term “secure location” shall mean a location wherein a clerk, or other personnel are nearby a terminal when the terminal is accessible to purchasers, whereas an “insecure location” is a location where personnel are not always present when purchasers can access the terminal. An examples of a secure location is within a store or business establishment, where access to the terminal is not available to the general public when the store is closed and when the store is open an employee of the location can easily observe the terminal. An example of an insecure location would be a location wherein the terminal is freely accessible at all times by the public, and is not in a position to be closely observed by staff, for example outside a store, or at a public station.

In use, the purchaser approaches the terminal, enters information about the purchase via the keypad, and enters bills into the bill reader. After the bills have been accepted by the bill reader, the terminal provides the purchaser the good or service being purchased (e.g. a prepaid phone PIN, increased value for a calling card or smart card, a transit ticket, etc.) As seen in FIG. 4, a bill reader 41 for use in the invention includes a means for entering bills 45, an acceptor head 46 and bill stacker 47. After bills have been placed in the means for entering bills 45, typically a tray or aperture to receive the bill, the acceptor head 46 verifies the value of the bill by means known in the art. If the bill is rejected it is returned to the purchaser. If the bill is accepted by bill reader 41 it is stored in bill stacker 47. Bill reader 41 also has a communication port (not shown), preferably a RS232 port, with which to communicate with other devices.

In a preferred embodiment of the invention, as seen in FIG. 5, bill reader 41 is in communication with terminal 13 (and preferably a terminal with a card reader 24). Power plug 11 is used to power both bill reader 41 and terminal 10 via power supply 8 and power supply cord 9. Communication cable 100 connects the communication means 35 and the communication means within bill reader 41 to allow bill reader 41 to communicate with terminal 10. In a preferred embodiment, as best seen in FIGS. 7 and 8, bill reader 41 and terminal 10 are encased in a POS terminal 90 so that they appear to the purchaser as a single unit. The purchaser has access to and can operate the keypad 21, bill placement means 45, display 31, printer 23, and card reader 24. As seen in FIG. 8, as front plate 82 of POS terminal 90 is removed bill reader 41 and terminal 10 are recognizable.

In use, the purchaser approaches POS terminal 90, and uses keypad 21 and display 31 to select a purchase. POS terminal 90 can be used for the purchase of many goods or services typically available for sale at terminals or via vending machines. Preferably POS terminal 90 is used for the sale of goods or services that can be provided via the display 31 or printer 23. Examples of such goods and services include prepaid cellular or long distance phone time. Tickets or coupons can also be dispensed easily from printer.

Terminal 10 is used to provide the processing power for POS terminal 90. As best seen in FIG. 8, terminal 10 is preferably provided with software development kit 110 that can be run in a PC 120 under an operating system such as DOS or Windows. A library of routines for the bill reader 115 must be developed. The software for the terminal such as applications 125 and bill reader library 115 are developed in a programming language such as C or Basic and preferably include a set of precompiled routines and libraries specific for the terminal. The code is compiled by cross compiler 116 to generate the applications 125 needed to run the terminal and bill reader library 115. Cross compiler 116 converts the software developed in C or another programming language useable on PC 120 into an executable or library file that can be used by the terminal operating system 135.

After the applications 125 for use in the terminal 10 have been developed, they are downloaded from the PC 120 to the terminal 10 typically by means of the serial cable connected to the serial communication ports of the PC 120 and the terminal 10. Other download methods include remote software download using a POS modem, or from one POS Station to another POS Station using their serial ports and a communication cable.

Bill reader library 115 interfaces terminal 10 with bill reader 41. Bill reader library 115 will be part of the application 125 and provides the routines necessary to control and operate bill reader 41.

A group of routines (herein, the “Obtain cash Task”) 130 are needed that use the bill reader library 115 to perform the task of obtaining the cash. The Obtain cash Task is preferably part of the application 125.

Bill reader library 115 is a set of routines written for a specific bill reader 41 make and model. Bill reader library 115 provides the support for the specialized features and functions needed to recognize the currency to be accepted by bill reader 41 and to process the information about the bills. Bill reader library 115 is preferably written in the software language used to program the terminal 10, for example ANSI C. Bill reader library 115 is linked by the cross compiler 116 and linked to generate the applications 125 that are downloaded to the terminal.

Bill reader library 115 preferably includes the following routines:

1) Open Com Port

This routine is used to initialize the communication port 35 in the terminal 10 to which bill reader 41 will be connected. It sets the communication parameters: Baud Rate, parity, and Port number. It also allocates memory for the receiver buffer and transmitter buffer.

2) Close Com Port

This routine is used to reset the terminal communication port 35. It frees the memory allocated for the receiver buffer and transmitter buffer allowing other applications to use the port.

3) Initialize Bill Reader

This routine is used to initialize the software operating parameters of the bill reader 41. It will vary depending on the manufacturer of the bill reader, and may not be available for all models.

4) Enable Bill Reader

This routine is used to enable the bill reader 41 to accept bills.

5) Disable Bill Reader

This routine is used to prevent the bill reader 41 from accepting bills. If a bill is being processed while the command is received, the bill will be rejected and no more bills will be accepted.

6) Get Status

This routine is used to obtain the status from the bill reader 41 and update the bill reader data structure to reflect the current status.

7) Store Bill

This routine instructs the bill reader 41 to store the detected bill.

8) Reject Bill

This routine instructs the bill reader 41 to reject the inserted bill.

9) Display information

This routine formats and displays the inserted credit information at display 31. It typically displays the following messages: for the purchaser to insert cash; the amount of cash to be inserted; an indication that the denomination has been accepted; and the key that the user may press to cancel the task. After the first bill is inserted and processed, it displays the current credit information and remaining credit required to complete the transaction. At that time terminal 10 will no longer display information related to or accept information from the cancel key (or other input) that the user could earlier have used to cancel the transaction.

More applications may be implemented by combining the terminal user interface with the bill reader library 115. These applications are part of more complex events that may be used to determine the amount of bills entered in the POS terminal 90.

Implementing the task of obtaining cash from the purchaser includes a combination of the following user interface messages: bill reader 41 monitoring and status evaluation; clock monitoring to limit the time it takes to perform the task; keyboard and switches monitoring to detect the cancel key; and decisions made based on the sequence of events.

To facilitate the development of applications, preferably the bill reader library 115 becomes part of the Obtain cash task 130. Task 130 handles user interface and bill reader control, and it may be called by other applications.

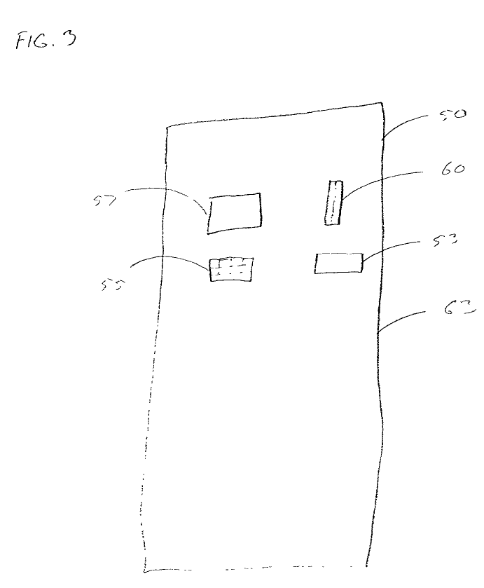

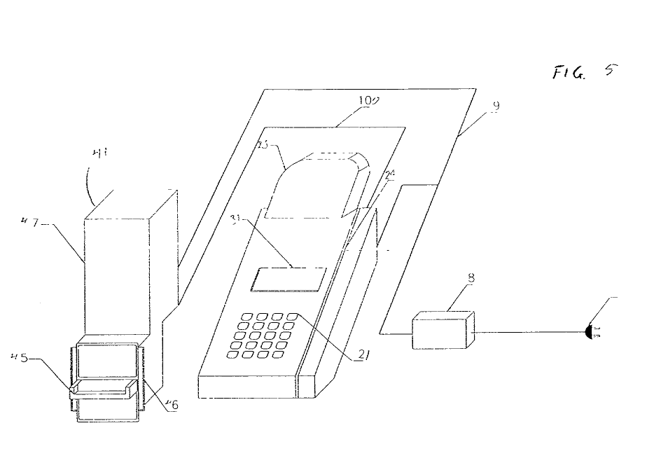

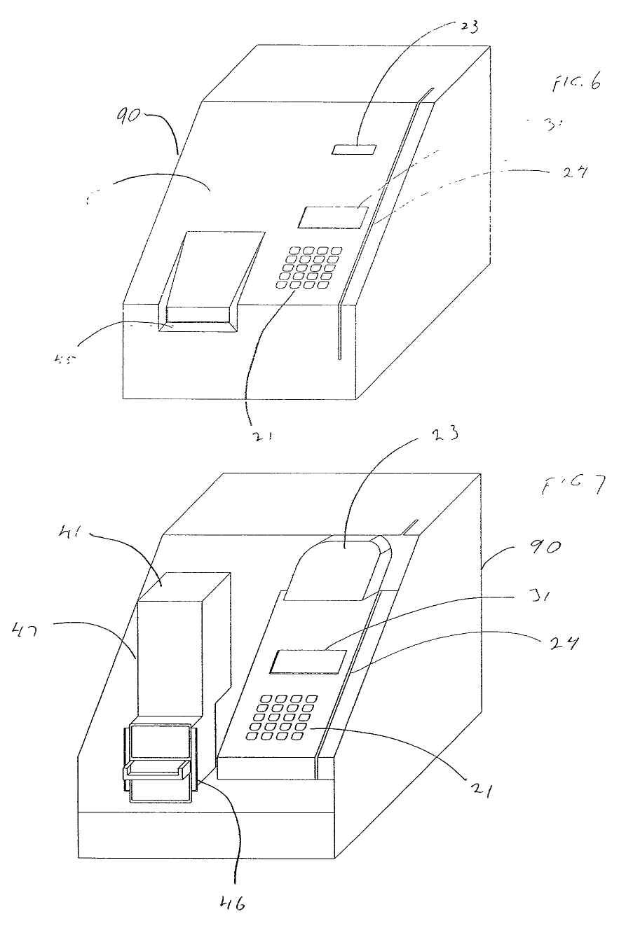

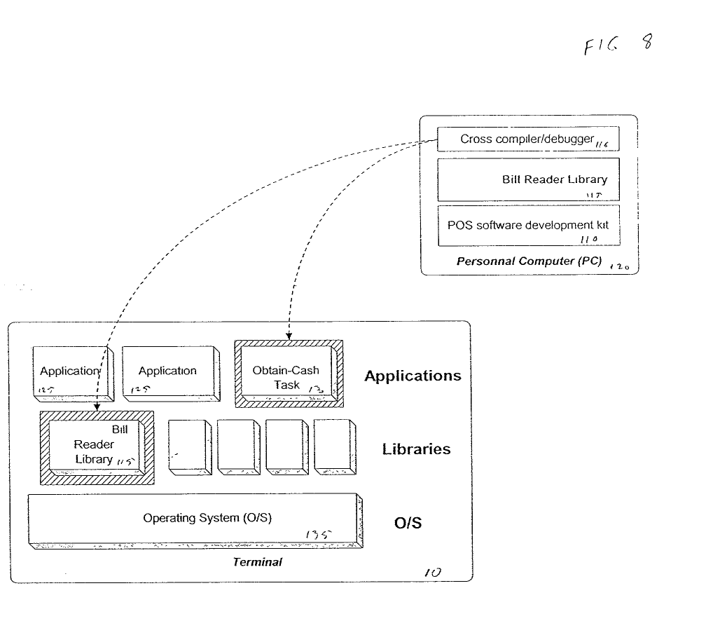

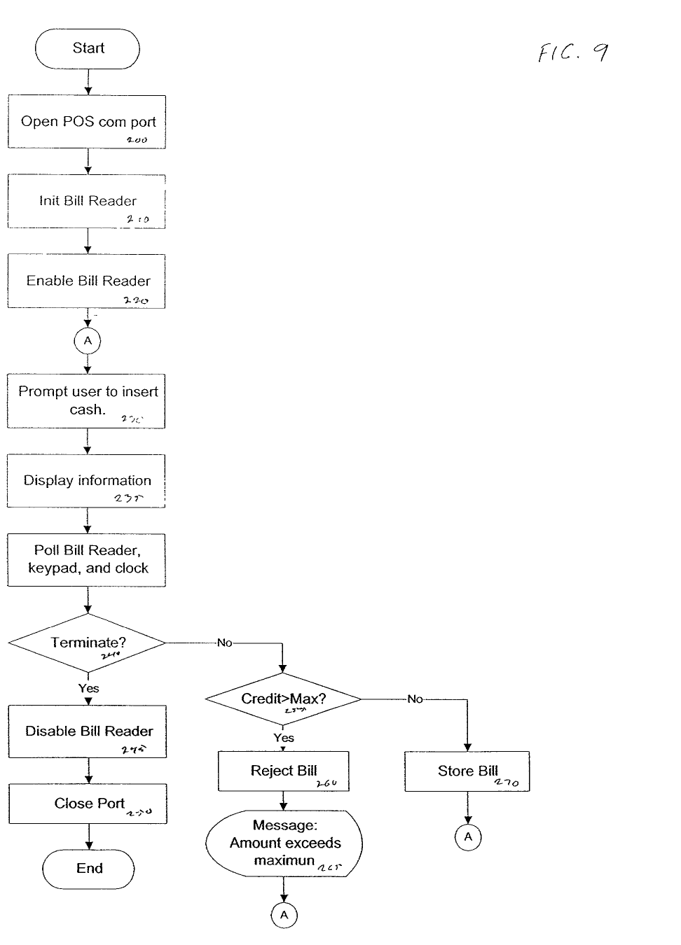

Most bill readers don't have the capability to return the bills that have been stored in the stacker. This must be taken into consideration when implementing the application. One approach to avoid having to return the bills, as seen in FIG. 9 is to prevent the user from inserting more credit than requested. To being the bill acceptance process, the Obtain Cash Task 130 begins by opening communications port 35 (step 200), initializing bill reader 41 (step 210) and enabling bill reader 41 (step 220). Once a purchaser has requested a transaction, display 31 prompts the user to insert cash (step 230) and display other information for the purchaser (step 235). The bill reader 41 status is then polled as described below, as is the keypad and the internal clock (step 240). If payment is completed the bill reader 41 is disabled (step 245) and the communications port 35 closed (step 250) until the next transaction.

Once the bill is detected and recognized, the Obtain Cash task 130 compares the inserted credit to the maximum amount of credit needed for the transaction (step 255). If the resulting credit exceeds the maximum amount, a Reject Command is sent to the bill reader, which results in the ejection of the bill (step 260). The POS terminal 90 then displays a pop up message informing the user that it has exceeded the requested amount (step 265). If there is still an amount needed to complete the transaction, the bill is stored (step 270).

The Obtain-Cash task 130 interacts with applications 125 by reading and updating the information on the bill reader data structure. The data structure is typically coded in ANSI C as described:

Typedef struct
{

long Amt_to_enter;
long Credit;
int Max_timeout;
int Ins_bill_timeout;
int Bill_rdr_status;
int Interrupt;

} Bill_Reader;

Where:

long: ANSI C definition for a long integer numeric field

int: ANSI C definition for an integer numeric field

Amt_to_enter Defines the maximum amount of credit that will be allowed to be inserted in the bill reader 41. The Obtain-Cash task 130 ends when the amount inserted matches the maximum amount. If the value is 0 it will consider that no maximum amount is set. The maximum amount of credit is typically represented in cents.

Credit: Is updated to represent the credit inserted in the bill reader stacker 47 since the beginning of the task. The Credit field is not automatically reset to zero and must be reset to zero by the application 125.

Max_timeout: Defines the maximum time in seconds for the Obtain-Cash task 130. When the Max_timeout is reached the Obtain-Cash task 130 will terminate returning control to the application 125. Any inserted bill that has not been processed will be rejected and the bill reader 41 will be deactivated until the next transaction is initiated. If the passed value is 0 the maximum timeout will have no effect.

Ins_bill timeout: Defines the maximum time in seconds between inserting bills. When the Ins_bill_timeout is reached the Obtain-Cash task 130 will terminate returning control to the application 125. The Ins_bill_timeout timer is reset every time a bill is successfully inserted. If the passed value is 0 the insert bill timeout will have no effect.

Bill_rdr_status: Field used to report the status of the bill reader 41. Part of the Obtain-Cash task 130 is to poll for the status of the bill reader 41 and inform the application 125 by updating the Bill_rdr_status. The Bill_rdr_status returns the following values:

TABLE 1
Returned Status Values

| Code | Value | Description |
|---|---|---|
| Idle | 0 | Value return when the Bill Reader |
| | | is Idle waiting for bank notes. |
| Reading | 1 | A valid bank note has been detected |
| Stacked | 2 | A valid bank note has been successfully stored in the |
| | | stacker. |
| Cancel | 3 | User pressed Cancel Key terminating the task |
| Interrupt | 4 | Interrupt field set to 1 terminating the task |
| Max_ | 5 | Maximum timeout reached terminating the task |
| timeout | | |
| Bill_ | 6 | Bill insertion timeout reached terminating the task |
| timeout | | |
| Stacker_ | −1 | Bill reader stacker error or full |
| err | | |
| Tamper_ | −2 | Tampering detected in Bill Reader |
| err | | |
| Com_ | −3 | Error opening the communication port |
| err | | |
| Bill_ | −4 | Bill reader is not responding |
| rdr_err | | |

Interrupt: The field used by the application 125 to interrupt the Obtain-Cash task 130. A value of 1 aborts the task. The field is reset to 0 when the task is initiated.

After the cross compiled applications 125, Obtain-Cash task 130 and bill reader library 115 are downloaded to terminal 10, bill reader 41 is connected to terminal 10 and stored with terminal 10 in POS terminal 90. POS terminal 90 is meant for storage in a secure location, i.e. it is a portable device and therefore can easily be stolen. As it may contain a number of bills in the bill stacker 47, it is therefore preferable to place POS terminal 90 in a secure location.

POS terminal 90 has the further advantage of being portable. For the purposes of this document portable means compact enough for placement on a countertop or table top and easily carried by a single person.

While the principles of the invention have now been made clear in the illustrated embodiments, it will be immediately obvious to those skilled in the art that many modifications may be made of structure, arrangements, and algorithms used in the practice of the invention, and otherwise, which are particularly adapted for specific environments and operational requirements, without departing from those principles. The claims are therefore intended to cover and embrace such modifications within the limits only of the true spirit and scope of the invention.

What is claimed is:

1. A method of manufacture of a point of sale terminal for placement in a secure location comprising the following steps:
(a) providing a payment terminal having:
(i) information output means;
(ii) means for user input;
(iii) a processor;
(iv) communication means for programming said processor;
(b) providing a bill reader;
(b) programming said processor to instruct said payment terminal to accept information from said bill reader via said communication means;
(c) connecting said bill reader to said payment terminal via said communication means.

2. The method of claim 1, wherein said payment terminal further comprises a card reader.

3. The method of claim 2 wherein said information output means comprises a printer.

4. The method of claim 2 wherein said information output means comprises a display.

5. The method of claim 4 wherein said information output means further comprises a printer.

6. The method of claim 5 wherein said means for user input comprises a keypad.

7. The method of claim 6 wherein said card reader is capable of reading credit cards.

8. The method of claim 7 wherein said card reader is capable of reading debit cards.

9. The method of claim 8 wherein said card reader is capable of reading smart cards.

10. The method of claim 9 wherein said payment terminal further comprises a modem.

11. The method of claim 10 wherein said communication means for programming is a RS-232 port.

12. A stand alone point of sale terminal for placement in a secure location and for use by a purchaser comprising:
(a) information output means;
(b) means for user input;
(c) a processor;
(d) a bill reader; and
(e) means for storing bills
wherein said terminal is portable.

13. The terminal of claim 12 further comprising communication means for programming said processor, wherein said processor accepts information from said bill reader via said communication means.

14. The terminal of claim 13 further comprising a card reader.

15. The terminal of claim 14 wherein said information output means comprises a display.

16. The terminal of claim 15 wherein said information output means further comprises a printer.

17. The terminal of claim 16 wherein said means for user input comprises a keypad.

18. The terminal of claim 17 wherein said card reader is capable of reading credit cards.

19. The terminal of claim 18 wherein said card reader is capable of reading debit cards.

20. The terminal of claim 19 wherein said card reader is capable of reading smart cards.

21. The terminal of claim 20 wherein said terminal further comprises a modem.

22. The terminal of claim 21 wherein said communication means for programming is a RS-232 port.

23. A method for a purchaser to make a purchase comprising the steps of:
(a) providing a portable, standalone point of sale terminal in a secure location having:
a bill reader;
information output means;
a processor;
means for user input;
(b) said purchaser selecting a purchase using said input means;
(c) said purchaser paying for said purchase by placing cash within said bill reader.

24. The method of claim 23 wherein said terminal further comprises communication means for programming said processor, and said processor accepts information from said bill reader via said communication means.

25. The method of claim 24 wherein said terminal further comprises a card reader.

26. The method of claim 25 wherein said information input means comprises a display.

27. The method of claim 26 wherein said information input means further comprises a printer.

28. The method of claim 27 wherein said means for user input comprises a keypad.

29. The method of claim 28 wherein said card reader is capable of reading credit cards.

30. The method of claim 29 wherein said card reader is capable of reading debit cards.

31. The method of claim 30 wherein said card reader is capable of reading smart cards.

32. The method of claim 31 wherein said terminal further comprises a modem.

33. The method of claim 32 wherein said communication means for programming is a RS-232 port.

34. A method of manufacture of a point of sale terminal for placement in a secure location comprising the following steps:
(a) providing a payment terminal adapted for receiving monetary value information via cards or via manual input;
(b) providing a bill reader;
(c) programming said payment terminal to receive monetary value information from said bill reader;
(d) connecting said bill reader to said payment terminal.
